(19) United States
(12) Patent Application Publication
(10) Pub. No.: US 2016/0101647 A1
(43) Pub. Date: Apr. 14, 2016

(54) Fluid Shield Assembly

(71) Applicant: Charles T. Colvin, Juliette, GA (US)

(72) Inventor: Charles T. Colvin, Juliette, GA (US)

(21) Appl. No.: 14/509,701

(22) Filed: Oct. 8, 2014

(51) Int. Cl. B60B 7/04; B05B 15/04

(52) U.S. Cl. CPC B60B 7/04; B05B 15/0487; B60B 2900/351; B60B 2900/5114

(57) ABSTRACT

A fluid shield assembly for preventing a fluid applied to a tire from contacting a wheel includes the tire coupled to the wheel of a vehicle. A pair of shells is structured to form a closed ring. The shells may be positioned on the tire such that the shells surround the wheel. A rod is provided. The rod comprises a plurality of movable sections of the rod such that rod has a telescopically adjustable length. The rod is coupled between the shells such that the rod selectively adjusts a diameter of the shells to match a diameter of the wheel. Thus, the shells may prevent a fluid applied to the tire from contacting the wheel.

### BACKGROUND OF THE DISCLOSURE

### Field of the Disclosure

The disclosure relates to shield devices and more particularly pertains to a new shield device for preventing a fluid applied to a tire from contacting a wheel.

### SUMMARY OF THE DISCLOSURE

An embodiment of the disclosure meets the needs presented above by generally comprising a tire coupled to a wheel of a vehicle. A pair of shells is structured to form a closed ring. The shells may be positioned on the tire such that the shells surround the wheel. A rod is provided. The rod comprises a plurality of movable sections of the rod such that rod has a telescopically adjustable length. The rod is coupled between the shells such that the rod selectively adjusts a diameter of the shells to match a diameter of the wheel. Thus, the shells may prevent a fluid applied to the tire from contacting the wheel.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a fluid shield assembly according to an embodiment of the disclosure.

FIG. 2 is a front view of an embodiment of the disclosure.

FIG. 3 is a right side view of an embodiment of the disclosure.

FIG. 4 is an in-use view of an embodiment of the disclosure.

### DESCRIPTION OF THE PREFERRED EMBODIMENT

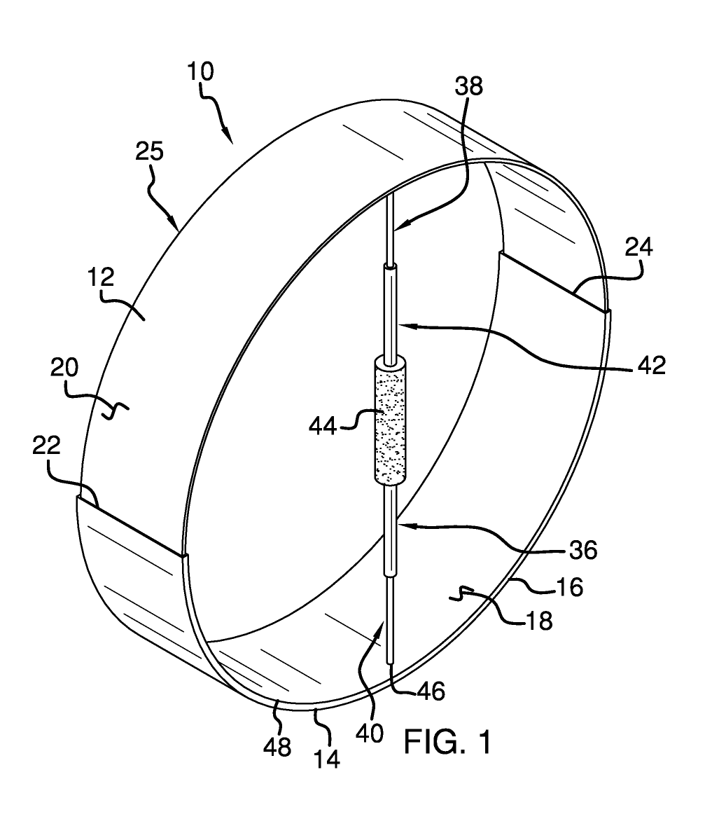

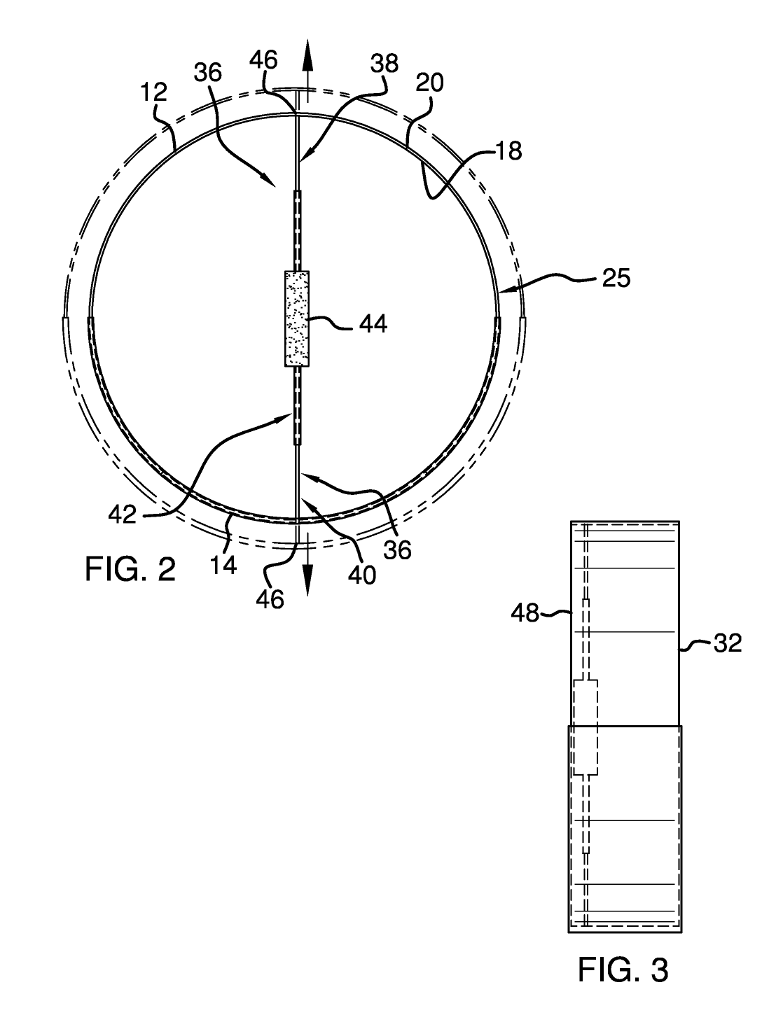

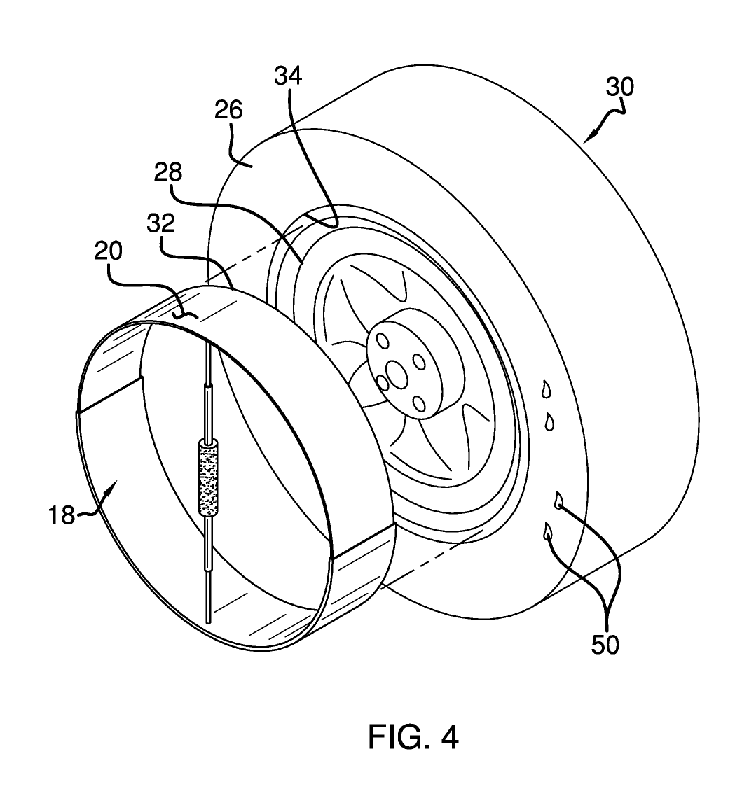

With reference now to the drawings, and in particular to FIGS. 1 through 4 thereof, a new shield device embodying the principles and concepts of an embodiment of the disclosure and generally designated by the reference numeral 10 will be described.

As best illustrated in FIGS. 1 through 4, the fluid shield assembly 10 generally comprises a pair of shells 12,14. The shells 12,14 each has an outer edge 16 extending between an inner surface 18 and an outer surface 20 of the shells 12,14. The inner 18 and outer 20 surfaces of the shells 12,14 are each curvilinear between each of a first end 22 and a second end 24 of the shells 12 such that the shells 12 each has a semi-circular shape.

Each of the first 22 and second 24 ends of a bottom one of the shells 12 is open. The first 22 and second 24 ends of the bottom shell 12 insertably receive an associated one of the first 22 and second 24 ends of a top one of the shells 14 wherein the shells 12,14 are slidably coupled together. Thus, the shells 12,14 form a closed ring 25. The shells 12,14 are positionable on a tire 26 coupled to a wheel 28 of a vehicle 30. The shells 12,14 are positionable such that a first lateral side 32 of the outer edge 16 of the shells 12,14 abuts the wheel 28. Additionally, the shells 12,14 are orientable so the outer surface 20 of the shells 12,14 is coextensive with an innermost edge 34 of the tire 26 wherein the shells 12,14 may form a barrier between the wheel 28 and the tire 26.

A rod 36 is provided. The rod 36 has an upper portion 38 and a lower portion 40 each slidably coupled to a central portion 42 of the rod 36. Thus, the rod 36 has a telescopically adjustable length. A grip 44 surrounds the central portion 42 of the rod 36. The grip 44 is centrally positioned in the central portion 42 of the rod 36 and extends toward each of the upper 38 and lower 40 portions of the rod 36. The grip 44 may be gripped to position the shells 12,14.

A free end 46 of each of the upper 38 and lower 40 portions of the rod 36 is coupled to the inner surface 18 of an associated one of the shells 12,14 such that the rod 36 bisects the closed ring 15. The rod 36 is positioned proximate a second lateral edge 48 of the outer edge 16 of the shells 12,14 such that the rod 36 is spaced away from the wheel 28 when the shells 12,14 are positioned on the wheel 28. The rod 36 selectively adjusts a diameter of the shells 12,14 to match a diameter of the wheel 28. Thus, the shells 12,14 may prevent a fluid 50 applied to the tire 26 from contacting the wheel 28. The fluid 50 may be a chemical tire cleaner or other similar fluid.

In use, the diameter of the shells 12,14 is adjusted to match the diameter of the wheel 28. The fluid 50 is applied to the tire 26 after the shells 12,14 are positioned on the wheel 28. The tire 26 is cleaned while the shells 12,14 are positioned on the wheel 28. The shells 12,14 are removed from the wheel 28 after the tire 26 has been cleaned.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A fluid shield assembly comprising:
a pair of shells structured to form a closed ring, said shells being configured to be positioned on a tire on a wheel such that said shells surround the wheel; and
a rod, said rod comprising a plurality of movable sections of said rod such that rod has a telescopically adjustable length, said rod being coupled between said shells such that said rod selectively adjusts a diameter of said shells to match a diameter of the wheel wherein said shells are configured to prevent a fluid applied to the tire from contacting the wheel.

2. The assembly according to claim 1, further comprising said shells each having an outer edge extending between an inner surface and an outer surface of said shells, said inner and outer surfaces of said shells each being curvilinear between each of a first end and a second end of said shells such that said shells each has a semi-circular shape.

3. The assembly according to claim 2, further comprising each of said first and second ends of a bottom one of said shells being open such that said first and second ends of said first shell insertably receives an associated one of said first and second ends of a top one of said shells wherein said shells are slidably coupled together.

4. The assembly according to claim 3, further comprising said shells being positionable such that a first lateral side of said outer edge of said shells abuts the wheel having said outer surface of said shells being coextensive with an innermost edge of the tire wherein said shells are configured to form a barrier between the wheel and the tire.

5. The assembly according to claim 1, further comprising said rod having an upper portion and a lower portion each being slidably coupled to a central portion of said rod, a free end of each of said upper and lower portions of said rod being coupled to an inner surface of an associated one of said shells such that said rod bisects said closed ring, said rod being positioned proximate a second lateral edge of an outer edge of said shells such that said rod is spaced away from the wheel when said shells are positioned on the wheel.

6. A fluid shield assembly comprising:
a pair of shells, said shells each having an outer edge extending between an inner surface and an outer surface of said shells, said inner and outer surfaces of said shells each being curvilinear between each of a first end and a second end of said shells such that said shells each has a semi-circular shape;
each of said first and second ends of a bottom one of said shells being open such that said first and second ends of said first shell insertably receives an associated one of said first and second ends of a top one of said shells wherein said shells are slidably coupled together having said shells forming a closed ring;
said shells being positionable such that a first lateral side of said outer edge of said shells abuts a wheel having said outer surface of said shells being coextensive with an innermost edge of a tire coupled to the wheel wherein said shells are configured to form a barrier between the wheel and the tire;
a rod, said rod having an upper portion and a lower portion each being slidably coupled to a central portion of said rod such that rod has a telescopically adjustable length, a free end of each of said upper and lower portions of said rod being coupled to said inner surface of an associated one of said shells such that said rod bisects said closed ring, said rod being positioned proximate a second lateral edge of said outer edge of said shells such that said rod is spaced away from the wheel when said shells are positioned on the wheel, said rod selectively adjusting a diameter of said shells to match a diameter of the wheel wherein said shells are configured to prevent a fluid applied to the tire from contacting the wheel.
